(19) United States
(12) Patent Application Publication
(10) Pub. No.: US 2011/0022804 A1
(43) Pub. Date: Jan. 27, 2011

(54) METHOD AND SYSTEM FOR IMPROVING AVAILABILITY OF NETWORK FILE SYSTEM SERVICE

(76) Inventors: Arun Avanna Vijayakumar, Bangalore (IN); Anantha Keerthi Banavara Ramaswamy, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/554,988

(22) Filed: Sep. 8, 2009

(30) Foreign Application Priority Data
Jul. 24, 2009 (IN) 1744/CHE/2009

(51) Int. Cl. G06F 12/00; G06F 15/16

(52) U.S. Cl. 711/126; 711/E12.001; 709/203

(57) ABSTRACT

A method and system for improving availability of a network file system service are disclosed. In one embodiment. a method of a client device for improving an availability of a network file system service in a network of the client device and a file server includes receiving a user request. The method also includes selectively caching data associated with the user request and serviced by the file server to a storage device associated with the client device via a heuristics process which is based on one or more measurable parameters of the network. The method further includes forwarding the data from the file server or the storage device to service the user request.

### RELATED APPLICATIONS

Benefit is claimed under 35 U.S.C. 119(a)-(d) to Foreign application Serial No. 1744/CHE/2009 entitled “Method And System For Improving Availability Of Network File System Service” by Hewlett-Packard Development Company, L.P., filed on 24 Jul. 2009, which is herein incorporated in its entirety by reference for all purposes.

### BACKGROUND

A computer network may comprise one or more file servers and a plurality of client devices, for example work stations. Each of the file servers may be a computer attached to the computer network that has a primary purpose of providing a shared storage of computer files that can be accessed by the client devices. A network file system may be a computer file system or protocol that supports sharing of the computer files serviced by the file servers over the computer network. The network file system may provide a transparent remote access, allowing users on the client devices to share and/or access resources of the network file system serviced by the file servers. A cache file system may be a technology designed to speed up accessing some of the computer files serviced by the file servers of the computer network. This may be accomplished by storing copies of the computer files on a local hard disk of each client device so that if any of the computer files is accessed again, they may be accessed from the local hard disk at a higher speed than the speed of accessing the computer files from the file servers.

However, the network file system may become unavailable or its service may be disrupted when the file servers are rebooted or when there is an intermittent networking issues, for example a linkage failure, in the computer network. The telecommunication industry has been trying to solve this problem by installing backup file servers which can replace the file servers in case of a failure. The current solution may improve availability of the network file system service, where the availability may refer to a proportion of time the network file system is in a functioning condition, but the solution may be a pricey one. The cache file system may be used to improve the availability even when there is a failure in the network file system. That is, the cache file system may be used to serve a user request as long as data needed for fulfilling the request is available as cached data in the local disk. However, the cache file system may not be any help when the data is not available in the local hard disk.

### BRIEF DESCRIPTION OF THE DRAWINGS

Embodiments of the present invention are illustrated by way of examples and not limited to the figures of the accompanying drawings, in which like references indicate similar elements and in which:

FIG. 1 illustrates a block diagram of a network having an exemplary network file system for increasing an availability of a network file system service, according to one embodiment;

FIG. 2A illustrates an exemplary method for using a response time of the file server of FIG. 1 as a criterion to improve the availability of the network file system service, according to one embodiment;

FIG. 2B illustrates an exemplary method for using an amount of retransmission from the file server of FIG. 1 as a criterion to improve the availability of the network file system service, according to one embodiment;

FIG. 2C illustrates an exemplary method for using a type and a bandwidth of the network as criteria to improve the availability of the network file system service, according to one embodiment;

FIG. 3 illustrates an exemplary network which includes multiple NFS server/client devices for improving an availability of a network file system service, according to one embodiment; and

FIG. 4 illustrates a process flow chart of an exemplary method for improving an availability of a network file system service in a network of a client device and a file server, according to one embodiment.

Other features of the present embodiments will be apparent from the accompanying drawings and from the detailed description that follows.

### DETAILED DESCRIPTION

A method and system for improving an availability of a network file system service are disclosed. According to various embodiments of the present invention, an availability of a network file system service may be improved for a network comprising a file server and a client device. This may be achieved by caching data in a storage device coupled to the client device via a heuristic process based on measurable parameters of the network. As the heuristic process enhances storing those data which are likely to be accessed later by the client device, the availability of the network file system service may be improved.

In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

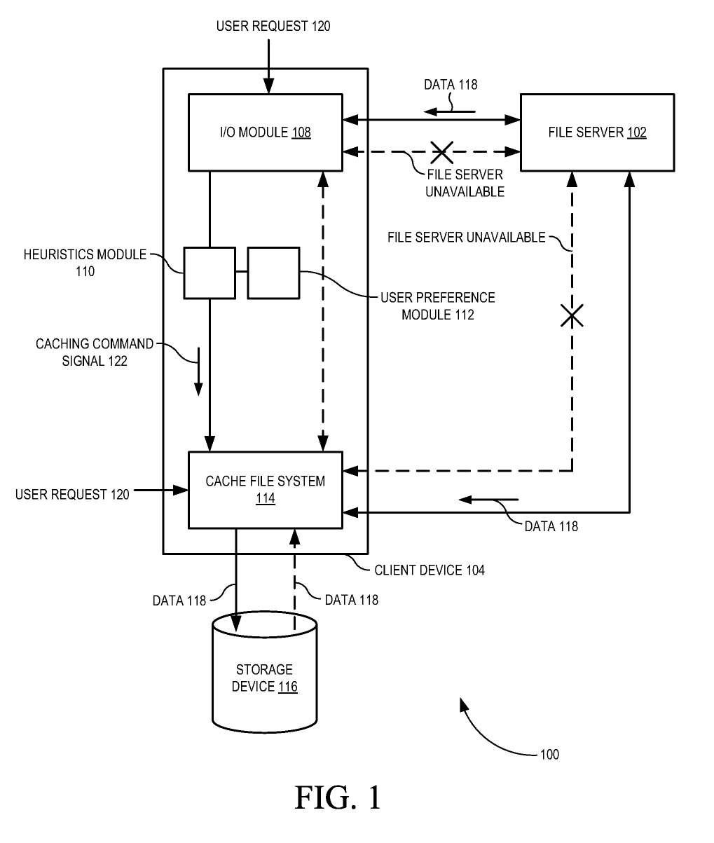

FIG. 1 illustrates a block diagram of a network 100 having an exemplary network file system for improving an availability of a network file system service, according to one embodiment. In FIG. 1, the network 100 comprises a file server 102 and the client device 104. The network 100 may be a wide area network, a local area network, and the like. The file server 102 may be a dedicated file server or a non-dedicated file server. A dedicated file server may be generally designed specifically for use as a file server, with one or more client devices, such as workstations, attached for reading and writing files, databases, etc. The client device 104 may share files with other client devices on the network 100 directly, by turning on its “server” service and taking another role as a non-dedicated file server. The network file system may be based on one of a Network File System (NFS), an Andrew File System (AFS), NetWare Core Protocol (NCP), a Server Message Block (SMB), etc. Although FIG. 1 illustrates a single file server and a single client device, it is appreciated that the embodiments illustrated in FIG. 1 may be extended to a network having multiple file servers and client devices.

As illustrated in FIG. 1, the client device 104 includes an input/output (I/O) module 108, a heuristics module 110, a user preference module 112, and a cache file system 114. The cache file system 114 may be CacheFS or another type of cache file systems. Moreover, the client device 104 is coupled to a storage device 116, such as a local disk, a remote storage, etc.

In operation, the client device 104 may try to access data 118, which has been already cached to the storage device 116 using the cache file system 114, when a user request 120 associated with the data 118 is processed by the I/O module 108. The use of the cache file system 114 may provide a faster access to the data 118 than accessing the data 118 from the file server 102. However, when the data 118 is not available in the storage device 116, then the data 118 is serviced from the file server 102, provided that the file server 102 is available. Additionally, the heuristics module 110 and/or the user preference module 112 may evaluate the data 118 to determine whether to cache the data 118 to the storage device 116 based on a set of criteria. On one hand, the evaluation may prevent unnecessary caching of the data 118 from filling the storage space of the storage device 116. On the other hand, the evaluation may proactively cache the data 118 and other relevant data so that the network file service in the network 100 can be continued even when the file server 102 is no longer accessible or too slow to access.

In the client device 104, the I/O module 108, which performs an I/O operation such as read or write, is configured to forward the user request 120 for the I/O operation or other network file system service to the file server 102. For example, an I/O operation on of the client device 104 may be forwarded to the file server 102 as the user request 120 so that the data 118 pertaining to the I/O operation and residing at the file server 102 can be accessed. Alternatively, the user request 120 may be directed to the cache file system 114 when the file server 102 is not accessible. Then, the data 118 may be accessed from the storage device 116 using the cache file system 114.

In FIG. 1, when the file server 102 is online and the data 118 accessed from the file server 102 is not yet cached, the heuristics module 110 may perform a heuristics process based on measurable parameters of the network 100, such as a data access pattern of the client device 104, a response time of the file server 102 in servicing the user request 120, an amount of retransmission encountered during the service fulfilling the user request 120, a responsiveness of the file server 102 as measured on the client device 104 when servicing the user request 120, a transport protocol employed by the file server 102 and the client device 104, security attributes of the network 100 connecting the file server 102 and the client device 104, etc. The heuristics process may determine whether to cache the data 118 to the storage device 116 and may forward a caching command signal 122 to the cache file system 114 accordingly.

In one embodiment, the heuristics process may be based on the data access pattern of the client device 104 where the data 118 is evaluated for caching with respect to a location of the data 118 and metadata associated with the data 118. That is, if the access pattern of the data 118 indicates numerous I/O operations directed to a file containing the data 118, the heuristics module 110 may generate the caching command signal 122 to the cache file system 114. Then, a portion or the entirety of the file can be cached to the storage device 116, provided that the data 118 is subjected to other heuristics based intelligence built into the heuristics module 110.

The heuristics process may be also based on the response time of the file server 102 in servicing the user request 120. This may involve monitoring the response time of the file server 102 as measured by the client device 104. If the response time is greater than a threshold server response time, the data 118 is cached in the storage device 116 which may be more readily accessible to the client device 104, provided that the data 118 is subjected to other heuristics based intelligence built into the heuristics module 110.

In addition, the heuristics process may be based on the amount of retransmission encountered during the service fulfilling the user request 120. The process may include monitoring of packets dropped on the network 100 as measured at the network end point on the client device 104 and/or monitoring of the amount of packet retransmission on the network 100 as measured on the client device 104. If the amount of retransmission is greater than a threshold retransmission value, the data 118 is cached in the storage device 116 which is more readily accessible to the client device 104, provided that the data 118 is subjected to other heuristics based intelligence built into the heuristics module 110. The threshold retransmission value may be defined by the system administrator based on parameters, such as an acceptable tolerance, agreed quality of service (QoS) for the file server 102 and the client device 104 pair, etc. In case of a network with multiple file server and client device pairs, the threshold retransmission value may be different for each file server and client device pair.

Further, the heuristics process may be based on the responsiveness of the file server 102 as measured on the client device 104 when servicing the user request 120. The process may include monitoring a bandwidth of the network 100 and/or a load of the file server 102 as measured on the client device 104. The parameters that influence the bandwidth can include a packet size, a maximum packet size that can be transmitted end to end without the packet being fragmented, and the link layer limits. One of the methods to measure the responsiveness of the file server 102 as measured on the client device 104 may include directing a NULL_PROC request from the client device 104, for example an NFS client device, to the file server 102, for example an NFS server. Then, the time delay between the request and the response may be measured at the client device 104. If the parameters that influence the responsiveness of the file server 102 are less than their corresponding threshold values, the data 118 is cached in the storage device 116, provided that the data 118 is subjected to and passes other heuristics based intelligence built into the heuristics module 110.

Moreover, the heuristics process may be based on the transport protocol employed by the file server 102 and the client device 104. If the file server 102 and the client device 104 employ a user datagram protocol (UDP), the network 100 may be more prone to retransmission and dropping of the packets. So, the heuristics module 110, when configured aptly, in conjunction with the cache file system 114 can choose to store the data 118 in the storage device 116, provided that the data 118 is subjected to and passes other heuristics based intelligence built into the heuristics module 110.

Additionally, the heuristics process may be based on the security attributes of the network 100 connecting the file server 102 and the client device 104. If the network 100 over which a secure or confidential file is accessed is not secure enough, the file server 102 and the client device 104 can employ external cryptographic techniques or other external encryption techniques to achieve an acceptable level of quality of protection (QOP). However, the adoption of these external encryption and cryptographic technique may consume a lot of computation bandwidth of the file server 102 and the client device 104, thus causing a reduced quality of the network file system service. The heuristics module 110 in conjunction with the cache file system 114 may choose to setup mechanisms and send the caching command signal 122 to store the data 118 on more secure and readily available storage device 116 rather than accessing the confidential file from the file server 102 over an insecure network.

In one embodiment, the user preference module 112 in conjunction with the heuristics module 110 can evaluate the data 118. For example, the user preference module 112 may enable caching of the data 118 based on a set of rules configured by the system administrator. For example, the system administrator may choose to configure rules to store the entirety of a file containing the data 118 in the storage device 116 rather than just the data 118 that is being accessed by the client device 104. Once data is selectively cached based on one or more of the heuristics processes and the user configured rules described above, the cached data can be used to improve availability of the file server 102.

In one embodiment, the cache file system 114 can be configured to honor access control rights (ACL) for the data 118 stored on the storage device 116. In such a case, the user request 120 may be preceded by a request for access rights to access the data 118. A consistency of the data 118 that has been cached may be validated by using post-operation attributes received by the cached file system 114 from the I/O module 108, where the cache file system 114 may provide different flavors of consistency checks, such as a strict consistency or weak consistency check. The strict consistency check ensures the cached file on the storage device 116 is consistent at any point in time with its original version residing on the file server 102. The weak consistency check ensures data consistency at the beginning and at the end of any operation for the most of time, but is not as costly in terms of its performance as many other consistency flavors. Although examples in FIG. 1 are illustrated in terms of a file, it is appreciated that the embodiments can be extended to any file objects, such as a file, a directory, etc.

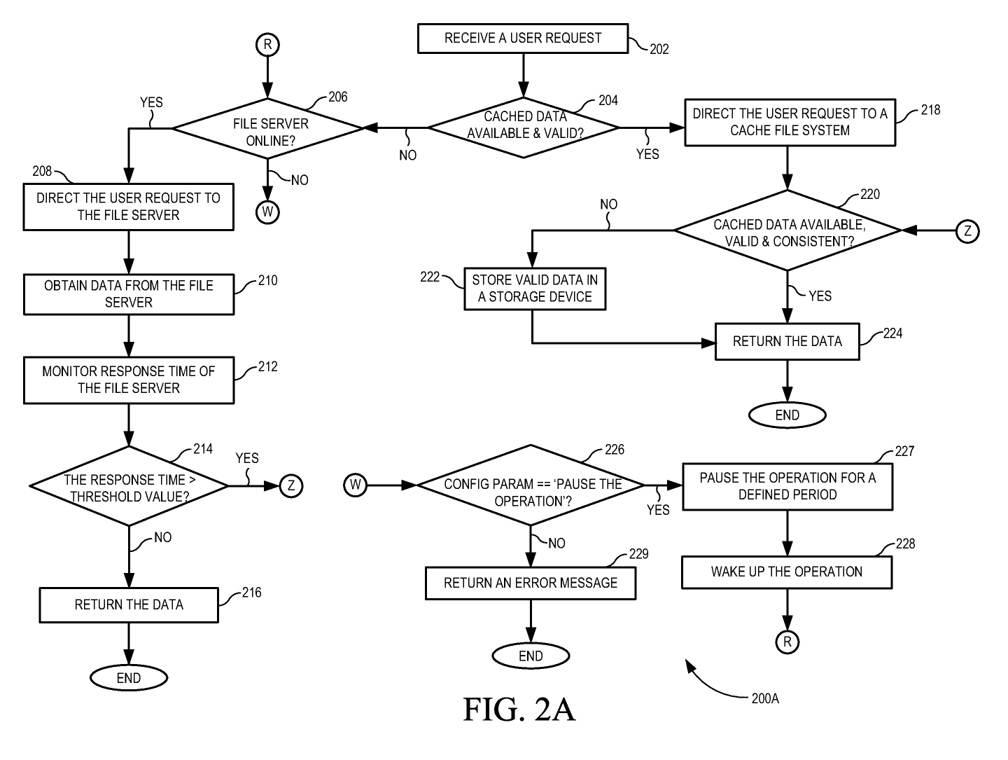

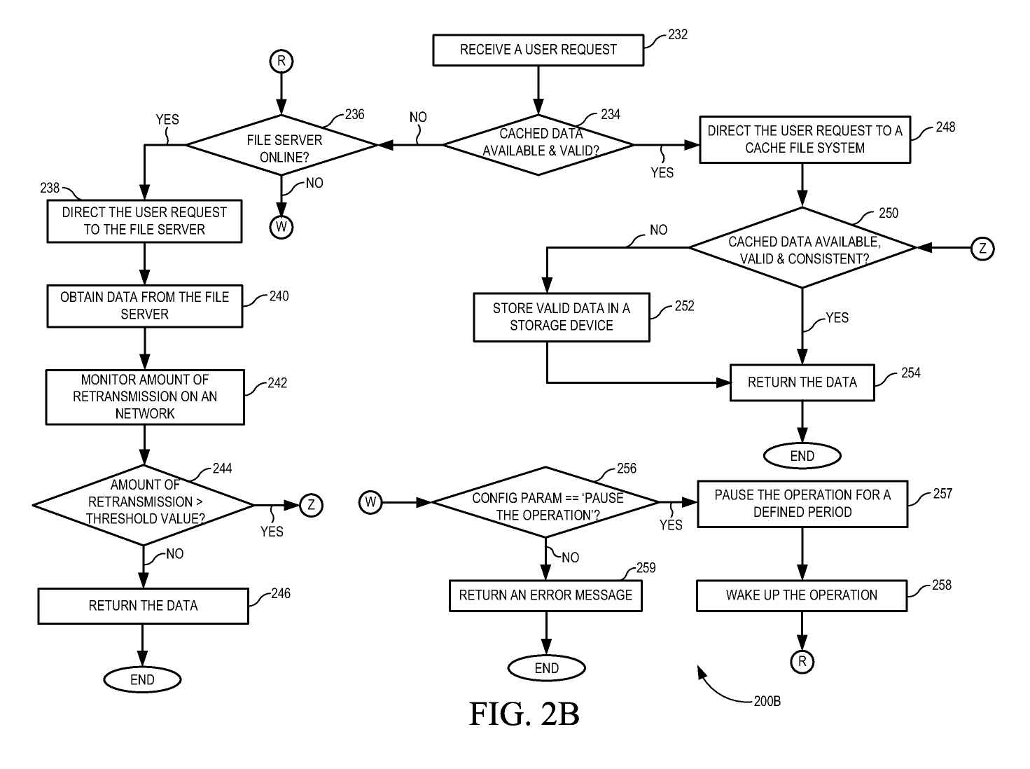

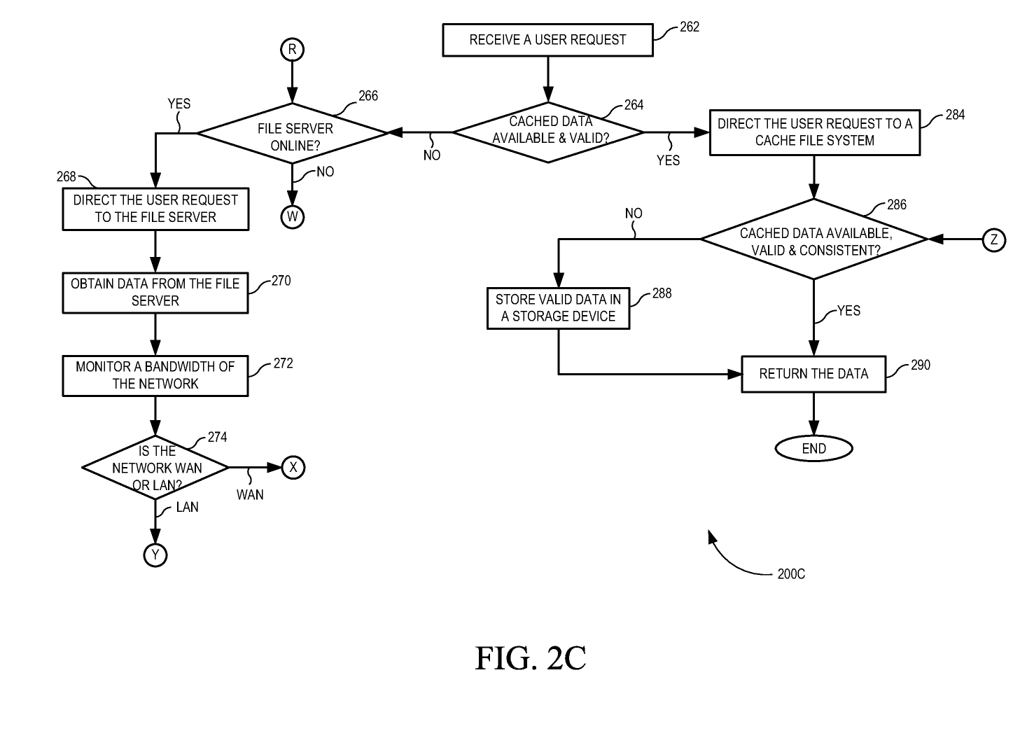

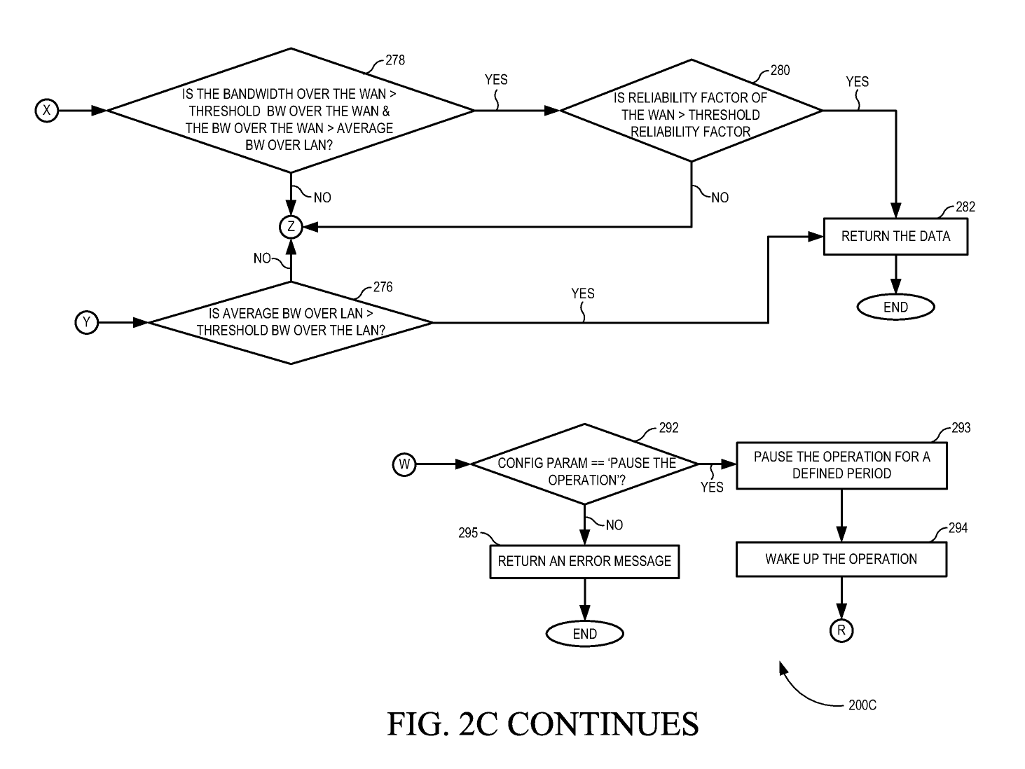

FIG. 2A illustrates an exemplary method 200A for using the response time of the file server 102 of FIG. 1 as a criterion to improve the availability of the network file system service, according to one embodiment. Although FIG. 2A illustrates one of the heuristics processes performed by the heuristics module 110, it is appreciated that the heuristic module 114 can also setup other mechanism(s) or heuristics process(es) based on a combination of factors. For example, the heuristics process may be based on the data access pattern of the client device 104, the responsiveness of the file server 102 as measured on the client device 104 when servicing the user request 120, the transport protocol employed by the file server 102 and the client device 104, and/or the security attributes of the network 100 connecting the file server 102 and the client device 104, etc.

As illustrated in FIG. 2A, at step 202, the user request 120 for a network file system service, for example, an I/O operation such as read or write the data 118, is received by the I/O module 108 of the client device 104. At step 204, it is determined whether the data 118 is available in the storage device 116 and whether the data 118 is valid. If both of the conditions are met, then step 218 is performed. At step 218, the user request 120 is directed to the cache file system 114 to perform the I/O operation. Subsequently at steps 220 and 224, the user request 120 is serviced using the data 118 residing in the storage device 116.

If any of the two conditions is not fulfilled in step 204, it is determined whether the file server 102 is online at step 206. If the file server 102 is online, the user request 120 is directed to the file server 102. If the file server 102 is offline, it is determined whether a configuration parameter for the network file system is set to “pause the operation” at step 226. If the configuration parameter, i.e., the config param, is set to pause the operation, then the user request 120 or its ensuing operation is either paused for a defined period at step 227. Then, at step 228, the network file system is awakened after the defined period if the file server 102 is back online. If the configuration parameter is not set for the pausing of the operation, then the user request 120 is returned with an error message, such as “the service temporarily unavailable” at step 229.

At step 208, the user request 120 is directed to the file server 102. At step 210, the data 118 is obtained by the client device 104 from the file server 102. At step 212, the response time by the file server 102 for carrying out the user request 120 and returning the result, for example, the data 118, back to the client device 104 is monitored. At step 214, it is determined whether the response time of the file server 102 is greater than a threshold value or threshold response time of the file server 102. If the response time is less than the threshold value, the data 118 serviced from the file server 102 is returned or forwarded to service the user request 120 at step 216.

If the response time is greater than the threshold value, then the data 118 is checked for availability in the storage device 116 at step 220. If the data 118 is available among cached data of the storage device 116, the data 118 is again checked for its validity and consistency with its original version residing at the file server 102 at step 220. If the availability, validity, and consistency of the data 118 are checked out, then the data 118 is forwarded to service the user request 120 at step 224. If any of the conditions is not met at step 220, then a valid version of the data 118, which may be obtained from the file server 102 if necessary, is stored in the storage device 116 at step 222 when the file server 102 is back online. Then, the data 118 is forwarded to service the user request 120 at step 224.

FIG. 2B illustrates an exemplary method 200B for using the amount of retransmission from the file server 102 of FIG. 1 as a criterion to improve the availability of the network file system service, according to one embodiment. Although FIG. 2B illustrates one of the heuristics processes performed by the heuristics module 110, it is appreciated that the heuristic module 114 can also setup other mechanism(s) or heuristics process(es) based on a combination of factors. For example, the heuristics process may be based on the data access pattern of the client device 104, the response time of the file server 102 in servicing the user request 120, the responsiveness of the file server 102 as measured on the client device 104 when servicing the user request 120, the transport protocol employed by the file server 102 and the client device 104, and/or the security attributes of the network 100 connecting the file server 102 and the client device 104, etc.

As illustrated in FIG. 2B, at step 232, the user request 120 for a network file system service, for example, an I/O operation such as read or write the data 118, is received by the I/O module 108 of the client device 104. At step 234, it is determined whether the data 118 is available in the storage device 116 and whether the data 118 is valid. If both of the conditions are met, then step 248 is performed. At step 248, the user request 120 is directed to the cache file system 114 to perform the I/O operation. Subsequently at steps 250 and 254, the user request 120 is serviced using the data 118 residing in the storage device 116.

If any of the two conditions is not fulfilled in step 234, it is determined whether the file server 102 is online at step 236. If the file server 102 is online, the user request 120 is directed to the file server 102. If the file server 102 is offline, it is determined whether a configuration parameter for the network file system is set to “pause the operation” at step 256. If the configuration parameter, i.e., the config param, is set to pause the operation, then the user request 120 or its ensuing operation is either paused for a defined period at step 257. Then, at step 258, the network file system is awakened after the defined period if the file server 102 is back online. If the configuration parameter is not set for the pausing of the operation, then the user request 120 is returned with an error message, such as “the service temporarily unavailable” at step 259.

At step 238, the user request 120 is directed to the file server 102. At step 240, the data 118 is obtained by the client device 104 from the file server 102. At step 242, the amount of retransmission over the network 100 that connects the file server 102 and the client device 104 is measured. If the amount of retransmission is less than the threshold value or threshold retransmission amount, then the data 118 serviced from the file server 102 is forwarded to service the user request 120. If the amount of retransmission is greater than the threshold value, then the data 118 is checked for availability in the storage device 116 at step 250. If the data 118 is available among cached data of the storage device 116, the data 118 is again checked for its validity and consistency with its original version residing at the file server 102 at step 250. If the availability, validity, and consistency of the data 118 are checked out, then the data 118 is forwarded to service the user request 120 at step 254. If any of the conditions is not met at step 250, then a valid version of the data 118, which may be obtained from the file server 102 if necessary, is stored in the storage device 116 at step 252 when the file server 102 is back online. Then, the data 118 is forwarded to service the user request 120 at step 254.

FIG. 2C illustrates an exemplary method 200C for using the type and bandwidth of the network 100 as criteria to improve the availability of the network file system service, according to one embodiment. Although FIG. 2C illustrates one of the heuristics processes performed by the heuristics module 110, it is appreciated that the heuristic module 114 can also setup other mechanism(s) or heuristics process(es) based on a combination of factors. For example, the heuristics process may be based on the data access pattern of the client device 104, the response time of the file server 102 in servicing the user request 120, the amount of retransmission encountered during the service fulfilling the user request 120, the transport protocol employed by the file server 102 and the client device 104, and/or the security attributes of the network 100 connecting the file server 102 and the client device 104, etc.

As illustrated in FIG. 2C, at step 262, the user request 120 for a network file system service, for example, an I/O operation such as read or write the data 118, is received by the I/O module 108 of the client device 104. At step 264, it is determined whether the data 118 is available in the storage device 116 and whether the data 118 is valid. If both of the conditions are met, then step 284 is performed. Otherwise, step 266 is performed. At step 284, the user request 120 is directed to the cache file system 114 to perform the I/O operation. Subsequently at steps 286 and 290, the user request 120 may be serviced using the data 118 residing in the storage device 116.

If any of the two conditions is not fulfilled in step 264, it is determined whether the file server 102 is online at step 266. If the file server 102 is online, the user request 120 is directed to the file server 102. If the file server 102 is offline, it is determined whether a configuration parameter for the network file system is set to “pause the operation” at step 292. If the configuration parameter, i.e., the config param, is set to pause the operation, then the user request 120 or its ensuing operation is either paused for a defined period at step 293. Then, at step 294, the network file system is awakened after the defined period if the file server 102 is back online. If the configuration parameter is not set for the pausing of the operation, then the user request 120 is returned with an error message, such as “the service temporarily unavailable” at step 295.

At step 268, the user request 120 is directed to the file server 102. At step 270, the data 118 is obtained by the client device 104 from the file server 102 to the client device 104. At step 272, the bandwidth (BW) of the network 100 that connects the file server 102 and the client device 104 is monitored or measured. At step 274, it is determined whether the network 100 is a wide area network (WAN) or a local area network (LAN). If the network 100 is the LAN, then it is further checked whether the average bandwidth over the LAN is greater than a threshold bandwidth over the LAN at step 276. If the average bandwidth over the LAN is greater than the threshold bandwidth, which may be set by the system administrator, then the data 118 is returned or forwarded to service the user request 120 at step 282. If the average bandwidth over the LAN is less than the threshold bandwidth over the LAN, then step 286 is performed.

At step 278, it is determined whether the bandwidth over the WAN is greater than a threshold bandwidth over the WAN, which may be set by the system administrator. At step 278, it is also checked whether the bandwidth over the WAN is greater than the average bandwidth over the LAN. If any of the conditions are not met, then step 286 is performed. If both of the conditions are met, then it is further determined whether a reliability factor of the WAN is greater than a threshold reliability factor at step 280, where the threshold reliability factor may be set by the network 100 or the system administrator. It is appreciated that the reliability factor is the ability of the WAN to withstand any changes in network parameters, such as changes in the packet round trip time, packet loss, amount of retransmission, etc. If the reliability factor is greater than the threshold reliability factor, the data 118 is forwarded to service the user request 120 at step 282. If the reliability factor is less than the threshold reliability factor, then step 286 is performed.

At step 286, the data 118 is checked for availability in the storage device 116. If the data 118 is available among cached data of the storage device 116, the data 118 is again checked for its validity and consistency with its original version residing at the file server 102. If the availability, validity, and consistency of the data 118 are checked out, then the data 118 is forwarded to service the user request 120 at step 290. If any of the conditions is not met at step 286, then a valid version of the data 118, which may be obtained from the file server 102 if necessary, is stored in the storage device 116 at step 288 when the file server 102 is back online. Then, the data 118 is forwarded to service the user request 120 at step 290. As illustrated in FIGS. 2A-2C, by servicing the user request 120 using the data 118, which is valid and consistent and which is cached in the storage device 116 using a heuristics process, a disruption of network file system service in the network 100 may be minimized.

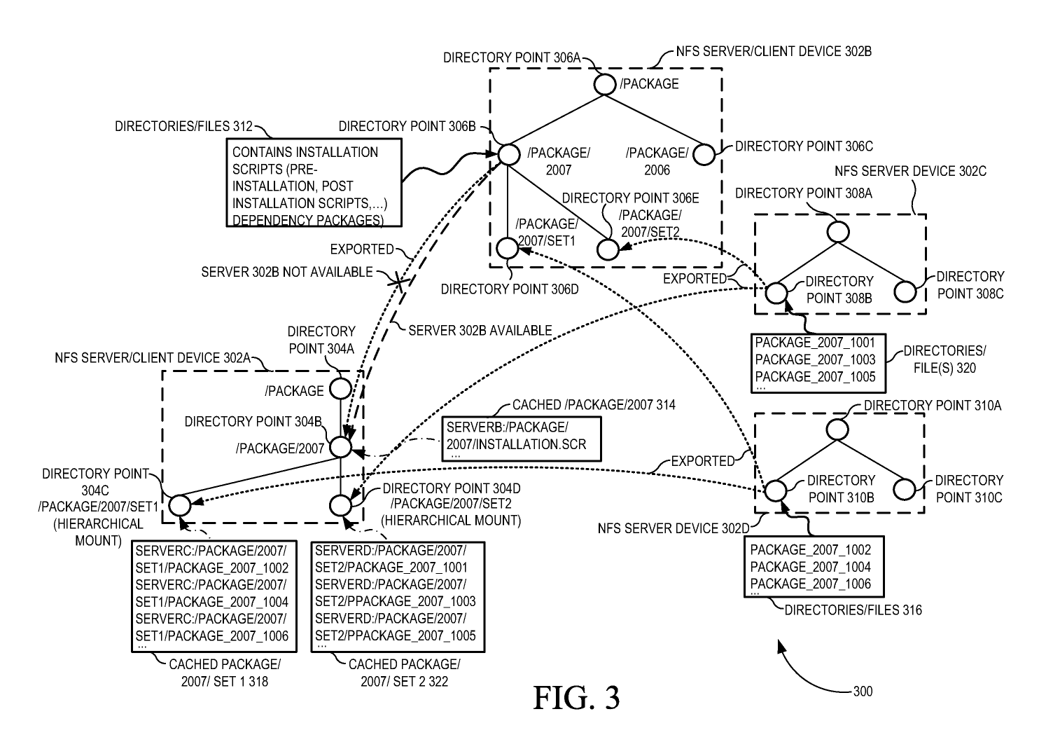

FIG. 3 illustrates an exemplary network 300 which includes multiple NFS server/client devices for improving an availability of a network file system service, according to one embodiment. It is appreciated that each of the NFS server/client devices may be an example embodiment of the file server 102 or the client device 104. It is also appreciated that each of the NFS server/client devices can be a dedicated server or non-dedicated server.

In FIG. 3, the network 300 includes NFS server/client devices 302A and 302B and NFS server devices 302C and 302D. The NFS server/client device 302A includes directory points 304A-D, where the term ‘directory point’ may refer to a point on which file systems that are exported from one or more servers in the network 300 are mounted. The NFS server/client device 302B includes directory points 306A-E. The NFS server device 302C includes directory points 308A-C. The NFS server device 302D includes directory points 310A-C.

As illustrated, the NFS server device 302C may export directories/files 320. Also, the NFS server device 302D may export directories/files 316. Then, the NFS server/client device 302B mounts the exported directory points 308B and 310B from the NFS server devices 302C and 302D, respectively. The directory point 308B from the NFS server device 302C is mounted on the directory point 306E on the NFS server/client device 302B, for example, “/PACKAGE/2007/SET2.” Similarly, the directory point 310B from the NFS server device 302D is mounted on the directory point 306D on the NFS server/client device 302B, for example, “/PACKAGE/2007/SET1.”

Further, the NFS server/client device 302B may export directories/files 312. The NFS server/client device 302A mounts the exported directory point 306B from the NFS server device 302B. It is mounted on the directory point 304B of the NFS server/client device 302A. In such a scenario, the NFS server/client device 302B may act as a client device to the NFS server 302C and 302D and as a server to the NFS server/client device 302A. Similarly, the NFS server/client device 302A may act as both client device and server in the network 300 illustrated in FIG. 3.

As illustrated, the directory points 304C and 304D of the NFS server/client device 302A are included under the directory point 304B. The directory point 304B is mounted from the directory point 306B of the NFS server/client device 302B, while the directory points 304C and 304D are mounted from the NFS server devices 302D and 302C, respectively. In one embodiment, the NFS server/client device 302A may cache the directories/files 312, 316 and 320 associated with the directory points 306B, 310B and 308B, respectively. The caching may be based on a combination of heuristics processes, as illustrated in FIGS. 1 and 2A-2C, performed on the network 300 and on the directories/files serviced between the NFS server/client devices 302A and 302B, and the NFS server devices 302C and 302D as well as the user configured set of rules. As illustrated, the NFS server/client device 302A includes cached /package/2007 314, cached /package/2007/set 1 318 and cached /package/2007/set 2 322.

When the NFS server/client device 302B goes offline, the NFS server client device 302A, acting as the client device, may try to access the directories/files 312 associated with the directory point 306B of the NFS server/client device 302B. Since the directories/files 312, 316 and 320 have been already cached by the NFS server/client device 302A, the NFS server/client device 302A may be able to access required directories/files from the cached files 312, 316 and 320 even when the NFS server/client device 302B is offline. As a result, the availability of the NFS service in the network 300 may be increased or improved.

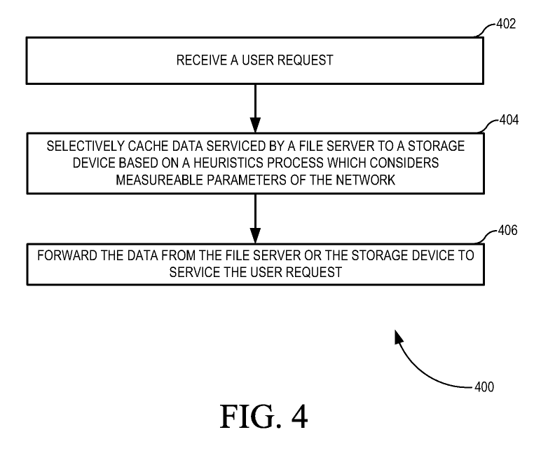

FIG. 4 illustrates a process flow chart of an exemplary method 400 for improving an availability of a network file system service in a network of a client device and a file server, according to one embodiment. In step 402, a user request is received. In step 404, data associated with the user request and serviced by the file server is selectively cached to a storage device associated with the client device via a heuristics process. In one embodiment, the heuristic process is based on one or more measurable parameters of the network. Exemplary measurable parameters may include a response time of the file server servicing the user request, an amount of retransmission encountered while servicing the user request, a data access pattern of the client device, a transport protocol employed by the file server and the client device, security attributes of the network connecting the file server and the client device, a responsiveness of the file server as measured on the client device when servicing the user request, and/or a bandwidth of the network.

In step 406, the data from the file server or the storage device is forwarded to service the user request. In one embodiment, the data is retrieved from the file server when the data is unavailable in the storage device. In an alternate embodiment, the data is retrieved from the storage device when the data is available in the storage device. Moreover, in one example embodiment, a computer-readable medium of the client device for improving an availability of the network file system service in the network of the client device and the file server having instructions that, when executed by the client device, cause the client device to perform a method illustrated in FIG. 4.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A method of a client device for improving an availability of a network file system service in a network of the client device and a file server, comprising:
receiving a user request;
selectively caching data associated with the user request and serviced by the file server to a storage device associated with the client device via a heuristics process which is based on at least one measurable parameter of the network, wherein the at least one measurable parameter comprises a response time of the file server servicing the user request; and
forwarding the data from at least one of the file server and the storage device to service the user request.

2. The method of claim 1, wherein the forwarding the data comprises retrieving the data from the file server when the data is unavailable in the storage device.

3. The method of claim 1, wherein the forwarding the data comprises retrieving the data from the storage device when the data is available in the storage device.

4. The method of claim 1, wherein the at least one measurable parameter further comprises an amount of retransmission encountered while servicing the user request.

5. The method of claim 1, wherein the at least one measurable parameter further comprises a data access pattern of the client device.

6. The method of claim 1, wherein the at least one measurable parameter further comprises a transport protocol employed by the file server and the client device.

7. The method of claim 1, wherein the at least one measurable parameter further comprises security attributes of the network connecting the file server and the client device.

8. The method of claim 1, wherein the at least one measurable parameter further comprises a responsiveness of the file server as measured on the client device when servicing the user request.

9. The method of claim 1, wherein the at least one measurable parameter further comprises a bandwidth of the network.

10. A client device for improving an availability of a network file system, comprising:
an input/output (I/O) module configured for processing a user request, wherein the user request is directed to a file server via a network;
a heuristics module coupled to the I/O module and configured for evaluating at least one measurable parameter of the network to determine whether to perform caching of data forwarded from the file server in response to the user request based on at least one of a data access pattern of the client device; a response time of the file server servicing the user request; an amount of retransmission encountered while servicing the user request; a transport protocol employed by the file server and the client device; security attributes of the network connecting the file server and the client device; and a responsiveness of the file server as measured on the client device when servicing the user request; and
a cache file system coupled to the heuristics module and configured for the caching of the data upon a receipt of a caching command signal from the heuristics module.

11. The device of claim 10, further comprising a user preference module coupled to the heuristics module for determining the caching of the data based on a set of rules configured by a system administrator of the network.

12. The device of claim 10, further comprising a storage device coupled to the cache file system for storing the data serviced by the file server.

13. The device of claim 10, wherein the network file system comprises a Network File System (NFS), an Andrew File System (AFS), a NetWare Core Protocol (NCP), and a Server Message Block (SMB).

14. The device of claim 10, wherein the cache file system comprises Cache File System (CacheFS).

15. A computer readable medium of a client device for improving an availability of a network file system service in a network of the client device and a file server having instructions that, when executed by the client device, cause the client device to perform a method comprising:
receiving a user request;
selectively caching data associated with the user request and serviced by the file server to a storage device associated with the client device based on a heuristics process which considers at least one measurable parameter of the network, wherein the at least one measurable parameter comprises a response time of the file server servicing the user request; and
forwarding the data from at least one of the file server and the storage device to service the user request.
